(19) United States
(12) Patent Application Publication
(10) Pub. No.: US 2026/0224960 A1
(43) Pub. Date: Aug. 6, 2026

(54) Training Device for Golf Swing

(71) Applicant: John Halmaghi, Novi, MI (US)

(72) Inventor: John Halmaghi, Novi, MI (US)

(21) Appl. No.: 19/141,281

(22) PCT Filed: Oct. 28, 2024
(86) PCT No.: PCT/US2024/053157

§ 371 Date: Jun. 19, 2025

(51) Int. Cl. A63B 69/36; A63B 71/06

(52) U.S. Cl. CPC A63B 69/3608; A63B 71/0622; A63B 2071/063; A63B 2071/068; A63B 2220/24; A63B 2220/40

(57) ABSTRACT

A training device and system for improving a user's golf swing including a vest to be worn on a user's body with a mobile device to be secured in the vest. An app is loaded into the mobile device that measures and analyzes certain angles of the user's body during a golf swing where the mobile device moves in conjunction with the wearer's body. The app preferably provides feedback and audible alert functionalities to notify users regarding reaching and maintaining certain angles of the user's body during the user's swing. The training device preferably has several push buttons on a user interface to record specific chosen swing control angles that correspond to different types of golf clubs.

### CROSS-REFERENCE TO RELATED APPLICATIONS

This application claims priority from U.S. Provisional Patent Application 63/596,769 filed on Nov. 7, 2023, entitled Smart Phone Enabled Training Method for Golf Swing, which is incorporated herein by reference.

Also, this application references Copyright Registration TXu 2-428-709 for Golf Aligner App, with an effective date of Apr. 30, 2024, which is incorporated herein by reference and the submitted work is provided.

### FIELD OF THE DISCLOSURE

This disclosure relates to a system with an app programmed for measuring, recording, analyzing, and reporting angles of the user's body positions during golf swings in a device adapted to be worn on a user's body. More specifically, the disclosure relates to a training device using a mobile smart device with a downloadable app designed to assist golfers in improving their swing with real-time feedback of their body positioning.

### BACKGROUND

Improving a golf swing can be enhanced through various training devices designed to promote better mechanics, timing, and consistency. Some popular types of training aids include:
Swing Trainers: These devices help develop a smooth, rhythmic swing. They often have weighted ends to promote proper swing path and tempo.
Impact Bags: These are filled bags that a golfer hits to help focus on impact position and promote a solid strike. They can also help reinforce the feeling of proper weight transfer.
Alignment Sticks: Simple yet effective, alignment sticks can be used to improve alignment, ball position, and swing path. Placing them on the ground or using them as a guide can enhance a golfer's setup.
Mirror Training or recording: A large mirror or videotaping allow a golfer to observe his or her stance, grip, and follow-through. These provide visual feedback on form.
Putting Aids: While focusing on the full swing is important, putting aids like alignment mats or training cups can also help develop a consistent stroke and improve overall game performance.
Virtual Reality (VR) Simulators: These high-tech devices can simulate real courses and provide immersive training experiences, focusing on swing mechanics and shot accuracy.
Swing Analyzers: Devices like the Arccos or Blast Motion (both with sensors on the club grip) provide data on a golfer's swing mechanics, helping to understand strengths and weaknesses through metrics like swing speed, path, and tempo, using a smart phone app.

When using these training devices, consistency and practice are key. Using training apps leveraging technology to provide immediate feedback and analysis in conjunction with consistent practice can significantly enhance a golfer's understanding of his or her swing and help the golfer make more informed improvements. Measuring angles of the body for better understanding of mechanics of the golfer's swing can help analyze and refine swing technique and positioning to improve the golf swing. Making precise adjustments based on real-time feedback can help improve performance.

Certain prior art uses apps to assist with athletics and exercises, including tracking and storing data. Prior known exercise equipment incorporates such apps with hardware. Prior known smart devices, such as iPhone® devices, tablets, and pads have accelerometers that can sense and measure pitch, movement, and angles of the device (and thus its user or equipment in certain circumstances), and can supply that data to separate devices. An accelerometer is a component that detects its own acceleration and is commonly used in smart phones to determine the phone's orientation. Once the orientation is determined, the phone's software can react accordingly, such as by changing its display from portrait to landscape, or otherwise providing such information.

Mobile device exercise tracking companion apps sense movement via movement sensors, such as accelerometers built into a mobile device. Built-in sensors include an accelerometer, which measures acceleration, a gyroscope, which measures rotation, a magnetometer, which measures the magnetic field, and a barometer, which measures pressure. By analyzing the data from these sensors together, apps can accurately determine how a device is moving and positioned relative to its surroundings. For example, Apple Fitness+is a video on-demand guided workout streaming service that provides several video workout guides and routines from fitness professionals, displaying exercise statistics from the Apple Watch in the top-right corner of the video in real-time.

Further, a three-axis accelerometer measures linear acceleration and can sense the inclination, tilt, and orientation of the wearer's body when the movement of the body moves in conjunction with the accelerometer. A gyroscope measures angular velocity, or the rate of rotation on the X, Y, and Z axis. Apps can use accelerometer and gyroscope data to provide experiences based on real-time, motion-based information in apps.

Exercise equipment is known to use smart devices with apps to better perform activities. U.S. Pat. No. 10,413,773 discloses a workout machine with a physical machine adapted to function with a smart device having sensors and a complementary app. The workout machine is adapted to be used with a smart device with built-in accelerometers and gyroscopes plus an app.

A vest holding the mobile device adjacent to the wearer can be used so that the mobile device's movement corresponds to the wearer's movement.

A need exists for a user-friendly golf swing analysis solution using angles of the golfer's body that integrates with mobile technology.

### SUMMARY

The present disclosure provides a system with an app that utilizes the sensors of a smart phone or other wearable smart devices programmed for measuring and recording body angles during golf swings. The device having the app is adapted to be worn on a golfer's body on a vest, including a jacket, belt, harness, or similar holding mechanism, allows users to easily access real-time data, track their performance over time, and generate analysis and reports.

A preferred training device for improving a user's golf swing uses a vest to be worn on a user's body. A mobile device that has sensors and a user interface can be secured in the vest. An app loaded into the mobile device measures and analyzes certain angles of the user's body during a golf swing. The app program accesses the sensors of the mobile device to capture specific body angles. Data recording capabilities record such measurements. The user interface controlled by the app can initiate, analyze, and report on measurements of the body angles. This preferred embodiment of the app has further functional aspects of the software of the app that includes alerts to notify users of a desired or predetermined range of the body angles during the user's swing.

In summary, a preferred embodiment of the app is directed to a process and a method of execution of the software on a mobile computing device that may include a smart phone used in conjunction with a vest component that correspond to the angles of portions of the user's body.

From the perspective of the user, the system operates to monitor, record, and advise about body angles during swinging various golf clubs. The system provides real-time evaluation analysis.

In the system, the software operates via subroutines and code that measure angles and movement of the golfer's body. The logic of the routines and subroutines are shown in flow charts incorporated herein by reference. In a preferred embodiment, one aspect of the functionality of the app is shown in a flow chart to measure angles, and the structures and processes that deliver the functionality can be adopted for specific mobile devices, such as Apple or Android smart phones.

The methods and processes of using the app to improve the user's golf swing with a mobile device may include the steps of initiating a measurement, accessing sensor data on the mobile device, and displaying the recording information. A key process is measuring angles of the golfer's body while swinging a golf club.

In an embodiment, the output includes real-time audible beeps and instructions and similar notifications when playing back earlier swings of a golf club. Another innovative feature is presetting angles that best correspond to different types of golf clubs.

In a preferred embodiment of use with a smart phone, integration with existing mobile technology reduces the need for additional hardware. This preferred embodiment of an app allows the user to download an app on their existing smart phone.

While a preferred embodiment describes an app used on a smart phone, a unique mobile device could be attached to the chest or hips to perform the same function that an app does without the need for a downloaded phone app and phone. As disclosed, using a smart phone takes advantage of built-in components, such as known accelerometers and gyroscopes, but such components could be built into a mobile device as a specific stand-alone unit for just improving golf swings.

The disclosed app does not focus on specifics of a particular smart phone or language, rather the app may be used with Apple, Android, or even on a stand-alone device.

The disclosure offers a novel solution to improving the user's golf swing by leveraging existing mobile technology to measure and record golf swing movements and angles effectively. This application not only enhances user experience but also contributes to improved golf performance.

### BRIEF DESCRIPTION OF THE DRAWINGS

The above-mentioned and other features of this disclosure and the manner of obtaining them will become more apparent, and the disclosure itself will be best understood by reference to the following descriptions of devices, apps, and associated processes considered in conjunction with the accompanying figures, which are given as non-limiting examples only, in which:

FIG. 1 shows an example vest holding a mobile device with a downloaded app;

FIG. 2 shows an alternate two-piece vest for holding a mobile device with a downloaded app; and

FIG. 3 shows an example screen shot of the user interface to record specific chosen angles.

Additional features of the present disclosure will become apparent to those skilled in the art after consideration of the following detailed description of illustrative embodiments exemplifying the best mode of carrying out the disclosure.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the disclosure, but is merely representative of those embodiments.

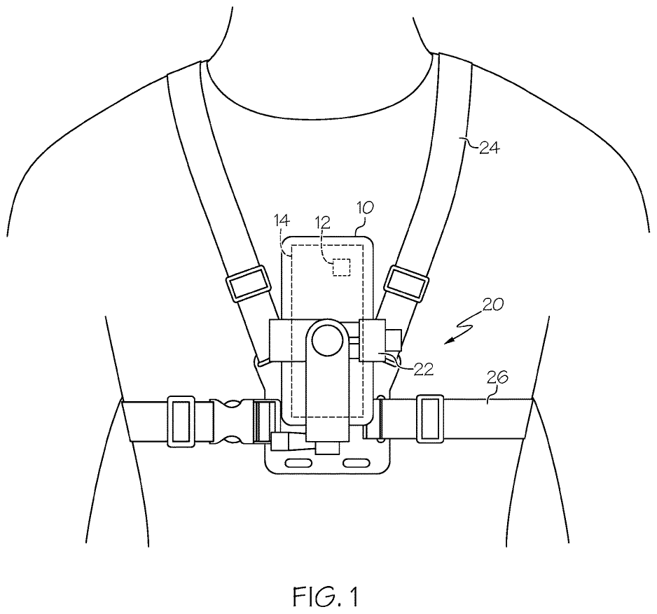

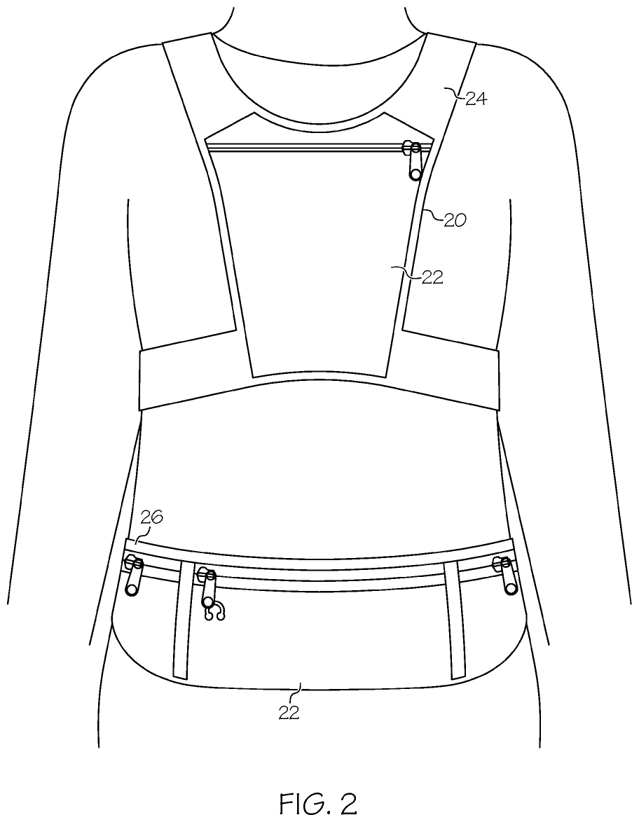

As disclosed, a training device uses a mobile device 10, such as a smart phone, with downloadable app 12 for assisting golfers in improving their swing. The app 12 can be programmed for measuring and recording angles during golf swings. The mobile device 10 is adapted to be worn on a golfer's body on a vest 20, which can be a vest, jacket, belt, strap, harness, or similar holding mechanism. As shown in FIG. 1, an example vest 20 may include four straps 24 and a flat middle square plastic platform affixed to the straps 24. FIG. 2 shows a two-piece vest with a separate belt component that may hold the mobile device in a horizontal position in pouch 22 of the belt 26. Another aligner golf vest as part of a golf training system may be a jacket that is designed out of durable fabric for normal wear similar to a standard clothing vest or alternate designs such as an emergency personnel vest or a tactical vest with a variety of extendable antenna pointers, pen flashlights and laser pointers, which might be used in conjunction with this mobile device.

A preferred mobile device 10 and vest 20 are part of the overall architecture of the device and system that performs the desired function and work in conjunction with the app 12 to achieve the desired solution. The system is configured to perform actions of measuring body angles and providing input to the user to improve movement and technique during a golf swing.

The app 12 in the system is configured to perform functions that correspond to using different clubs and different angles and movements of the golfer's body during a swing.

The preferred disclosed app 12 builds on current iPhone apps that show the screen angle of the phone and may use similar functionality for Android versions. The app 12 has a feedback mechanism that gives the user instant feedback on how the spine and shoulders are angled during swinging. With the app 12 in a mobile device 10 in a pouch 22 placed mid-chest as an example to allow the user to place the mobile device 10 adjacent to the user's chest. As the user moves during swinging, the app 12 ideally provides prompt feedback as to the angle of the spine and chest in this example.

In a preferred embodiment, the app 12 is loaded in a mobile device 10, which is ideally a smart phone, held to the user's body with a vest 20 having a pouch 22 to secure the mobile device 10. As shown in FIGS. 1 and 2, the vest 20 is preferably made with shoulder straps 24 to hold the mobile device 10 adjacent to the chest in a vertical upright position (for certain measurements detailed below) and a belt 26 convertible on the hips or waist in a horizontal position for measuring the hip tilt rotation, i.e. Hip Turn Tilt Angle (HTA). The pouch 22 of FIG. 1 is preferably rotatably mounted on the vest 20 so it can be in a fixed vertical position on the user's chest, but rotated to a fixed horizontal position when the pouch 22 on the vest 20 is in a belt position. The pouch 22 shown in the chest position of FIG. 2 as a V-shaped pouch could also be used as a square pouch, and a pouch 22 in a separate belt component may be adapted to hold the mobile device 10 in a horizontal position. The app 12 may automatically determine the horizontal or vertical orientation of the mobile device 10 in certain instances.

### The App

The app 12 to assist golfers is designed to be downloaded onto a mobile device 10, including a smart phone or other wearable device. It may leverage existing sensors (such as accelerometers and movement monitors) to provide accurate analysis of the wear's golf swing. The app 12 is designed to help golfers improve their swing technique by measuring and recording specific angles during swinging of their golf clubs.

In a preferred embodiment, the app 12 can have user registration, log-in (including using social media credentials), and direction to a home screen 14 on the mobile device 10. The app 12 can redirect the user to the home screen 14 after logging in successfully.

Once on the home screen 14, the user can initiate the measuring functionality on the app 12 and place the mobile device 10 in a vest 20 on their chest or hip, such as by using a strap 24 or belt 26 with a pouch 22.

The method of operation may include:
Installing the app 12 on the user's mobile device 10.
Initiating the measurement and analysis process via the app interface.
Placing the mobile device 10 adjacent to a portion of the user's body.
The app 12 accessing the sensors of the mobile device 10 to gather necessary data.
The data is processed, displayed, and provided to the user, while being recorded for future reference.

Key Features may include:
a. Real-Time Monitoring: Users can view, monitor, and analyze their swing in real time.
b. Data Recording: The app 12 records swing data over specified periods, allowing users to track improvement immediately or over time.
c. User Interface: An intuitive user interface presents data in a clear and accessible manner, including graphs and data comparisons.
d. Alerts and Notifications: Users receive audible feedback when their swing angles and body positioning achieve ideal predefined thresholds in real time, such as angle or range of body positioning. App 12 preferably gives real-time verbal/voice feedback for positioning.
e. Export Functionality: Users can export their data in various formats for sharing with golf pros or others.

The app 12 measures several preferred angles for a golfer during a full swing. These angles have predetermined minimums based on which type of club is used with a mobile device 10—in a vertical position: Spine Angle (SA), Shoulder Turn Angle (STA), and Shoulder Impact Angle (SIA), and in a preferred horizontal position at belt level for Hip Turn Tilt Angle (HTA).

Spine Angle (SA) is the initial angle measured and tracked when the mobile device 10 starts from an upright vertical position which is considered ZERO degrees. The measurement can range from 0-50 degrees, but preferably 30-45 degrees, based on the selected Swing Control Angle (SCA) corresponding to the club being used.

For Shoulder Turn Angle (STA), once the Spine Angle (SA) is achieved and maintained during the first half (45 degrees) of backswing/back turn, the app 12 monitors the rightward rotation of the mobile device 10 starting at the 45 degree back turn and past 90 degrees rotation while simultaneously tilting the upper left corner down and right upper corner up to monitor the angle of the shoulders as they tilt down at the end of the backswing/back turn and providing audible feedback in regard to the angle that needs to be achieved. For a left-handed golfer, the rotation would be leftward.

Regarding Shoulder Impact Angle (SIA), as the mobile device 10 returns from the right-side rotation to the left, the app 12 monitors when the left upper corner of the mobile device tilts back up and the right upper corner of the mobile device 10 tilts back down reaching a specific angle (approximately 30-60 degrees up/higher than the starting position). Again, for a left-handed golfer, the orientation would be opposite.

With mobile device 10 placed in a preferred horizontal belt area position, the Hip Turn Tilt Angle (HTA) measurement automatically begins to measure the horizontal turn of the mobile device 10 regardless of the SCA chosen and measures only the horizontal angle of the hip turn.

The app 12 can measure and preferably record data (or screen recording) from a STARTING vertical starting position known as ZERO position, which is enabled by a ZERO voice command. When the user feels that they are in the correct vertical position they speak out the command ZERO, and the app 12 zeros out all of the numbers and understands that this is the starting position from where all other measurements begin. The device 10 will be enabled into different achievable angular ranges that are pre-chosen by the user pressing buttons that are configured into the app 12.

The app 12 preferably has multiple predefined Swing Control Angles (SCA) that correspond to different golf clubs as examples:
D (Driver): 30-37 degrees
WO (Woods): 32-39 degrees
4-5-6 Irons: 34-41 degrees
7-8-9 Irons: 36-43 degrees
WE (Wedges): 38-45 degrees
Horizontal Hip Position: 17 degrees minimum and higher

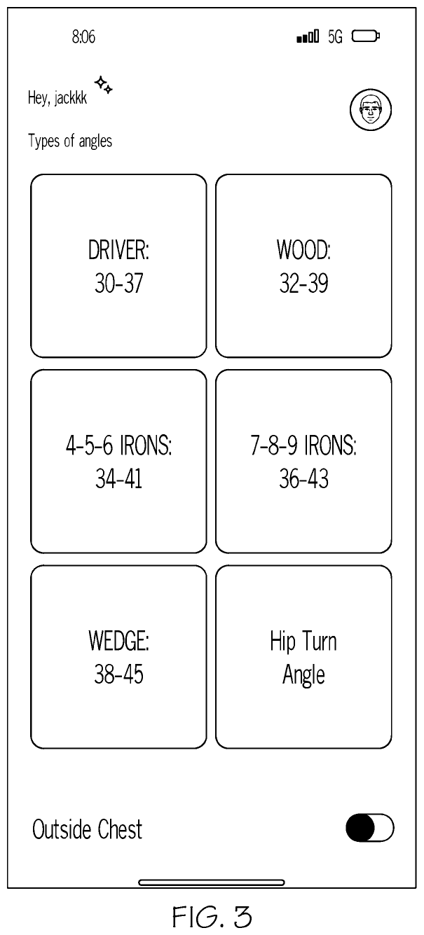

On a home screen 14, as a preferred example of FIG. 3, the app 12 enables five push buttons on a user interface to record specific chosen angles as Swing Control Angles (SCA) as named on the screen as:

| | | | | |
|---|---|---|---|---|
| DRIVER | WOOD | 4-5-6 IRONS | 7-8-9 IRONS | WEDGE |

which correspond per the table above to the range of degrees respectively. The Hip Turn Angle can be a sixth button.

Additional Functionality may include an audible beep to alert the golfer when each specific SCA range is achieved, enhancing their awareness during the swing. Each button setting correlates with the app 12 to have an audible beep when the golfer is at the predetermined angles for their spine, shoulders, and/or hips. Different feedback sounds can be programmed for when each of the three vertically enabled SCAs (SA, STA, SIA) is achieved, allowing golfers to identify the consistency of the angles being achieved and the progress and work on specific aspects of their swing.

For example, the D (Driver) setting button will have the app 12 beep a particular sound when the spine angle (SA) reaches minimum 30 degrees (down from ZERO vertical upright starting position) and does not exceed 37 degrees while staying in this position at address and during the first half of their backswing/turn back. Similarly, the WO (Woods) will beep between 32-39 degrees; the 4-5-6 irons between 34-41 degrees; the 7-8-9 irons between 36-43 degrees; and the WE (Wedges) between 38-45 degrees.

As an example, each SCA will tell the app 12 to have audible beeps as follows:
Spine Angle (SA): when this first SCA is achieved as the mobile device 10 is first tilted straight down vertically from the upright ZERO position (which is dictated by the user.)
Shoulder Turn Angle (STA): once the Spine Angle (SA) is achieved and maintained during the first half (45 degrees) of backswing/back turn, the app 12 begins to monitor the second half of the back turn providing audible beep feedback in regard to the shoulder angle that needs to be achieved at the end of the back swing. This angle ranges between 25-35 degrees for an optimal swing. The app 12 also provides a different audible sound feedback if the angle goes above 40 degrees. The 40 degree feedback allows the user to realize that the angle is too steep and not recommended. For a left-handed golfer, the rotation would be leftward.
Shoulder Impact Angle (SIA): The app 12 provides audible feedback when the shoulders reach a minimum of 30 degrees angle at impact. It also provides an additional and different audible feedback when this angle reaches greater than 40 degrees. The 40+degree feedback audible is for golfers who want to achieve maximum swing power when the proper Shoulder Angle at impact is achieved.

Spine Angle (SA) is the first position and is a vertical measurement from the upright user determined ZERO position. It measures between 30-45 degrees based on the SCA. This is a measurement that starts from the user defined ZERO position which is based on how the user stands upright vertically based on their chest anatomy. All audible feedbacks are heard when the range of angles for the SCA is achieved.

As a further example as a second measurement, Shoulder Turn Angle (STA) happens upon side/back rotation (backswing). The upper part of the mobile device 10 is parallel to the shoulders at the ZERO position. An ideal position of the shoulder line at the end of the backswing (STA) will be somewhat based on the SCA chosen by the golfer, but the range allowed is between 25-35 degrees for all clubs. A different beep is sounded when the SCA for the STA is achieved. The audible sound is preferably different than the first one used for spine angle (SA).

A third measurement can be “Shoulder Impact Angle (SIA)-After Side Rotation Through Impact”. It will be a range starting as device 10 is returning to original starting SA position from the backswing. The ideal measurement will start close to the original starting SA position. A different audible preferably beeps when the SIA is achieved. This rotation will require that the left upper corner of the device 10 move back up to and past original horizontal height and the right upper corner tilts down 30 degrees more than the starting SA zero horizontal position. A different audible will also be heard when the angle exceeds 40 degrees.

Different feedback sounds will ideally be provided when each of the three SCAs (SA, STA, SIA) is achieved, allowing golfers to identify their progress and work on specific aspects of their swing.

Ideally, the app 12 automatically generates summary data or screen recordings for each swing, allowing golfers to review and analyze their performance over time.

The app 12 may automatically, or with a tap/voice command or like, start a recording of either the screen or the angle data from 1-2 and continue for the next SCA, but the user cannot practically remove the device 10 from the pouch 22 to give physical recording commands, so automatic or voice commands are preferred. Summary data or screen recordings can be accomplished by user simply giving voice command using the word START or RECORD and can be stopped with voice command STOP.

The app 12 preferably enables functionality for both slow-motion and fast-motion playback options. Fast motion may be as fast as 2.5 seconds while slow motion can be any length of time with the mobile device 10 going back and forth between all points of measurement. Golfers can review their swings at their preferred speed, providing a comprehensive analysis of their technique. Different beeps or sounds are produced when each of the three SCAs are achieved in the playback also.

Recording functionality allows recording capabilities, allowing golfers to capture their swing data. The recording will preferably automatically trigger when the predefined angles are achieved. Summary data or screen recording may also be important that automatically turns on when angles are off after all of the rotations are done.

An additional feature with the mobile device 10 in a horizontal position measures the Hip Turn Tilt Angle (HTA) at the end of the backswing. The device 10 automatically detects when it is in a horizontal position and starts to beep when a minimum 17-degree angle (from horizontal) is achieved. In this instance, the app 12 can also preferably be used in the horizontal orientation position with the device 10 on a belt arrangement.

The app 12 can also measure Total Side Turn (TST) as a measurement of the total side turn from starting position, such as an ideal total turn of 90 degrees from the starting position with a possible beep when 90 degrees is achieved.

The app 12 is able to record all the angles and provide a summary at the end of a swing along with ideal numbers for club used: 1) Spine Angle (SA); 2) Shoulder Turn Angle (STA); 3) Shoulder Impact Angle (SIA); 4) Total Side Turn (TST) as separate recording; and 5) Hip Turn Tilt Angle (HTA), in which the HTA angle is preferably measured in a horizontal position.

The examples and ranges of angles that the app 10 can monitor and track can vary in range and type. Any of the angles can be programmed to have wider range of angles if needed.

The mobile device 10 preferably includes Bluetooth functionality.

Prerecorded swing recommendations are based on data of angle recordings and analysis. The app 12 can give verbal/voice feedback such as “Spine is too upright, lean down more” or “Right shoulder did not come down enough during swing”. For a more detailed example, if the STA is less than ideal the recording would say: “Consider dropping left shoulder down more while paying attention to not reversing spine and making sure that you feel right back pocket is turning backwards toward target and not swaying hips.”

Further, flow charts and code can show in detail various example routines and subroutines that together connect to create and deliver the complete functionality of the app 12. The unique set of functionalities direct the operation of a particular computing device in a system using a vest 20 worn by the user, such as a golfer.

This disclosure has been presented for purposes of illustration and description but is not intended to be exhaustive or limiting. Modifications and variations will be apparent to those of ordinary skill in the art. The example embodiments were chosen and described to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected by one skilled in the art without departing from the scope or spirit of the disclosure.

The uniqueness resides in how the software operates, including the structure and processes of the system that deliver the functionality, not the particular code that tells the device what to do. The invention in the following claims is independent of coding language.

What is claimed is:

1. A training device for improving a user's golf swing comprising:
a vest to be worn on a user's body;
a mobile device including sensors and a user interface, which can be secured in the vest; and
an app loaded into the mobile device that measures and analyzes certain angles of the user's body during a golf swing with a program for accessing the sensors to capture said angles and corresponding data with data recording capabilities to record measurements,
wherein the user interface is adapted for initiating measurements and accessing data for the user's golf swings.

2. The training device of claim 1 wherein the mobile device is a smart phone.

3. The training device of claim 1 wherein the app includes alert functionalities to notify users of a range of the angles during the user's swing.

4. The training device of claim 3 wherein the mobile device includes Bluetooth capabilities, and the alert functionalities include an audible beep and prerecorded swing recommendation recordings.

5. The training device of claim 1 wherein the sensors include an accelerometer and a gyroscope.

6. The training device of claim 1 wherein the user interface includes a home screen with a display, wherein the recorded data is shown on the display of the mobile device.

7. The training device of claim 1 wherein the app measures and analyzes certain angles of the user's body to include Spine Angle; Shoulder Turn Angle; and Shoulder Impact Angle.

8. The training device of claim 7 wherein the app further measures and analyzes Hip Turn Tilt Angle with the mobile device worn in the vest on a belt position on the user.

9. The training device of claim 1 having push buttons on the user interface to record specific chosen angles as Swing Control Angles that correspond to different types of golf clubs.

10. A training device for improving a user's golf swing comprising:
a vest to be worn on a user's body;
a mobile device including sensors and a user interface, which can be secured in the vest; and
an app loaded into the mobile device that measures and analyzes certain angles of the user's body to include a) Spine Angle; b) Shoulder Turn Angle; and c) Shoulder Impact Angle during a golf swing with a program for accessing the sensors to capture said angles and corresponding data with data recording capabilities to record measurements, wherein the app includes audible alert functionalities to notify users of a predetermined range of certain angles of the user's body during the user's swing.

11. The training device of claim 10 having push buttons on the user interface to record specific chosen angles as Swing Control Angles that correspond to different types of golf clubs.

12. The training device of claim 10 wherein a STARTING vertical uses a starting ZERO position that is enabled by a ZERO voice command, and the app zeros out all numbers and understands the starting ZERO position from where all other measurements begin.
